(19) United States
(12) Patent Application Publication
(10) Pub. No.: US 2009/0110617 A1
(43) Pub. Date: Apr. 30, 2009

(54) Radial Flow Reactor Design for High Volumetric Flows

(76) Inventor: William J. Koves, Hoffman Estates, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/926,523

(22) Filed: Oct. 29, 2007

(51) Int. Cl. B01J 8/02; B01J 19/00

(52) U.S. Cl. 422/219; 422/211

(57) ABSTRACT

A new radial flow reactor design is presented. The design includes a plurality of cylindrically shaped beds wherein the beds are sized to be nested one within another, and the beds are disposed within a housing.

### BACKGROUND OF THE INVENTION

This invention relates to the field of fluid-solid contacting devices. In specific, this invention relates to radial flow reactors, where solid catalyst particles contact a cross-flowing fluid.

A wide variety of processes use radial flow reactors to provide for contact between a fluid and a solid. The solid usually comprises a catalytic material on which the fluid reacts to form a product, or an adsorbent for selectively removing a component from the fluid. The processes cover a range of processes, including hydrocarbon conversion, gas treatment, and adsorption for separation.

Radial flow reactors are constructed such that the reactor has an annular structure and that there are annular distribution and collection devices. The devices for distribution and collection incorporate some type of screened surface. The screened surface is for holding catalyst or adsorbent beds in place and for aiding in the distribution of pressure over the surface of the reactor, or adsorber, and to facilitate radial flow through the reactor bed. The screen can be a mesh, either wire or other material, or a punched plate. For a moving bed, the screen or mesh provides a barrier to prevent the loss of solid catalyst particles while allowing fluid to flow through the bed. The screen requires that the holes for allowing fluid through are sufficiently small to prevent the solid from flowing across the screen. Solid catalyst particles are added at the top, and flow through the apparatus and removed at the bottom, while passing through a screened-in enclosure that permits the flow of fluid over the catalyst. The screen is preferably constructed of a non-reactive material. Radial flow reactors are designed to promote the distribution of a fluid for flow across a reactor bed that is comprised of a catalyst flowing through the reactor bed and are useful for the low pressure drop afforded in the design.

The screens or meshes used to hold the catalyst particles within a bed are sized to have apertures sufficiently small that the particles cannot pass through. A problem exists for high flow systems where there is pinning. Pinning is where the catalyst is held against the screen as fluid flows across the reactor, and is held with sufficient force from the flow of fluid that the catalyst no longer flows freely downward through the reactor. This can also lead to creating voids within the reactor bed where catalyst particles below the pinned particles leave the reactor bed and fluid flowing underneath the pinned particles does not react as a result.

Improved designs can overcome problems associated with high flow systems.

### BRIEF SUMMARY OF THE INVENTION

The invention is a radial flow reactor designed to overcome flow limitations associated with the current radial flow reactor. The invention comprises at least two reactor beds, where each reactor bed has an annular shape, and where a first reactor bed is nested within the second reactor bed, and where both reactor beds are disposed within a reactor housing. The reactor beds are sized to have an outer annular region between the reactor housing and the second reactor bed, and an inner annular region between the second reactor bed and the first reactor bed. The first reactor bed is also sized to have a cylindrical space defining a cylindrical pipe for the flow of fluid in the cylindrical pipe. The reactor has fluid flowing into the inner annular region, across the reactor beds and out the outer annular region and cylindrical pipe. Alternately, the flow can be reversed for this reactor, such that the flow is into the outer annular region and cylindrical pipe, across the reactor beds and out the inner annular region.

Other objects, advantages and applications of the present invention will become apparent to those skilled in the art from the following detailed description and drawings.

### BRIEF DESCRIPTION OF THE DRAWING

FIG. 1 is a drawing of a horizontal cross section of the reactor design; and

FIG. 2 is a drawing of a vertical cross section of the reactor design.

### DETAILED DESCRIPTION OF THE INVENTION

A problem with increasing the flow of fluid through the reactor is pinning of the catalyst causing catalyst holdup. Another problem is void blowing where the flow of fluid is sufficient to push catalyst away from the inlet screen causing problems with reactive operation. One method of dealing with this is to slow the flow within a reactor and to use multiple reactors, or to increase the size of the reactors and use more catalyst. However, this can be costly, and does not allow for increasing the flow through existing reactor assemblies.

The present invention overcomes problems associated with current reactor design. The present invention is an apparatus for fluid-solid contacting comprising a cylindrical housing for holding at least two reactor beds. The first reactor bed is an annular shaped bed having a first inner radius and a first outer radius, and the bed is comprised of catalyst disposed within the space between the first inner radius and the first outer radius. The second reactor bed is an annular shaped bed having a second inner radius and a second outer radius, and the bed is comprised of catalyst disposed within the space between the second inner radius and the second outer radius. The inner and outer radii of the beds are comprised of partitions for retaining the catalyst. In the present invention the inner radius of the second bed is greater than the outer radius of the first bed. The reactor beds are disposed within the housing, and the first reactor bed is nested inside the space defined by the inner radius of the second reactor bed.

The sizing of the beds, or the space between the outer radius and the inner radius, is determined to provide for the pressure drops across the beds and containment screens to be substantially equal. As such, the beds can have different distances between the outer circumferences of the beds and the inner circumferences of the beds, or distances between the respective outer and inner radii of the first and second beds.

The present design provide advantages over previous radial flow reactors. The advantages include lower pressure drops for the same flow over the same volume of catalyst. The flow rates fluid for reacting in the reactor can be increased more without reaching the limits such that pinning occurs. The design is more compact than the present reactor design of a single bed, and retrofitting a current reactor with the current design can be done without complete replacement of the reactor.

The partitions can be punched plates having holes in the plates sufficiently small to prevent the flow of catalyst through the plates. The plates are rolled into a cylindrical form to make the reactor partition. Another screen design currently uses wire screen supports for radial flow reactors with horizontal support rods. The design of screens for use in radial flow reactors is for a sufficient pressure drop to provide a uniform distribution of the flow of fluid through the reactor. A conventional well screen with profiled wires can be found in U.S. Pat. No. 2,046,458. The wires are helically wrapped around a plurality of longitudinal rods, and welded to the rods to define slots of predetermined widths. After the wires are welded to the rods to form the screen, the screen is opened and flattened. The flattened screen can then be rolled to from a cylindrical screen with the wires in the longitudinal direction and forming slots that run the length of the cylindrical surface of the screen. The screen can be rolled such that the wires are on the inner surface of the outer screen for a radial flow reactor, or rolled such that the wires are on the outer surface of the inner screen for the radial flow reactor.

In the context of this invention, when the terms cylindrical or cylindrically are used, they are intended to cover any thing having a substantially cylindrical shape, but is also intended to include eccentric cylindrical shapes such as a reactor having an elliptically shaped cross-section. Also, when using the terms cylindrical or cylindrically, it is intended to cover frustoconically shaped objects wherein the reactor beds have a substantially toroidally shaped cross-section, but in the axial direction the beds either taper to smaller cross-sectional radii, or flare to larger cross-sectional radii. In addition, the invention is described in terms of a reactor with catalyst beds comprising solid catalyst particles. However, the invention is meant to include monolithic catalyst beds shaped in an annular configuration. This design is also applicable to an adsorber, where the reactor beds are adsorbents used to remove a component from a fluid mixture. It is intended that the use of the term reactor bed includes an adsorbent bed for purposes of this invention.

The apparatus of the present invention further comprises a solid distribution conduit for directing the flow of catalyst into the top of the reactor beds, and a solid distribution conduit for collecting the flow of catalyst from the bottom of the reactor beds.

In one embodiment, the apparatus, comprising two concentric annular catalyst beds for a space between the two catalyst beds. The space is in fluid communication with a first fluid conduit for delivering a fluid to the catalyst beds. Around the outer catalyst bed is an outer space formed between the housing and the outer bed, and the inner catalyst bed forms a cylindrical pipe in the center of the inner bed. The outer space and the cylindrical pipe are in fluid communication with a second fluid conduit for collecting fluid that has passed through the catalyst beds. As an alternative, the flow can be reversed, and the second fluid conduit can supply the fluid reactants to the catalyst beds and the first fluid conduit can withdraw fluid that has passed through the catalyst beds.

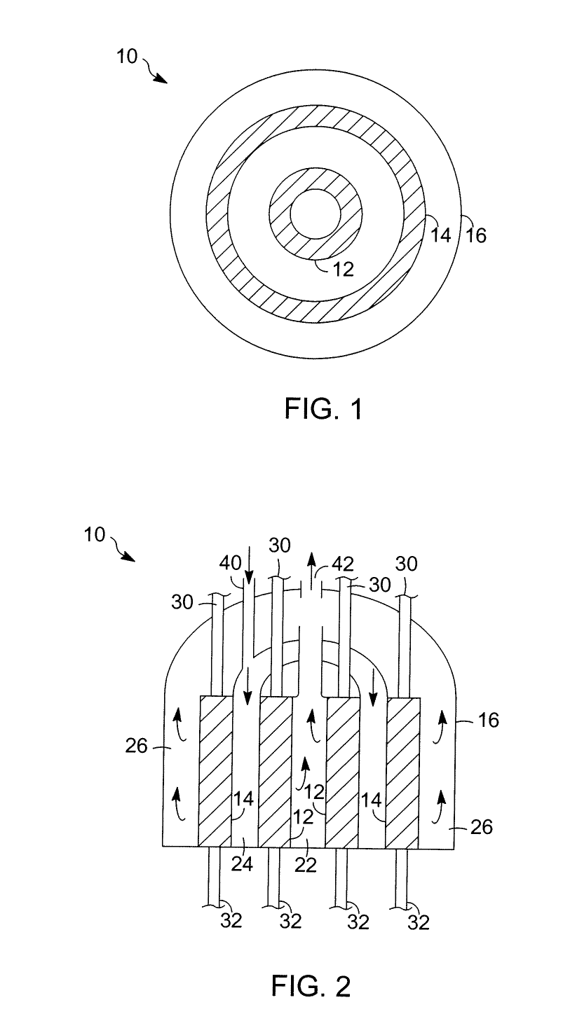

In the preferred embodiment, a horizontal cross-section of the apparatus is shown in FIG. 1. The apparatus 10 includes two catalyst beds, a first, inner bed 12 and a second, outer bed 14, disposed within a housing 16. A vertical cross-section, passing through the center of the apparatus 10 is shown in FIG. 2. The inner bed 12 has a first inner radius and a first outer radius. The first inner radius defines a cylindrical pipe 22 and serves as a conduit for the withdrawal of product from the apparatus 10. The outer bed 16 has a second inner radius that is greater than the first outer radius, and a second outer radius. The space between the inner bed 12 and outer bed 14 provides an inlet annular space 24 for the inlet distribution of a fluid to flow across the beds 12, 14. The apparatus 10 further includes a space between the outer bed 14 and the housing 16 providing an outlet annular space 26 for the withdrawal of product from the apparatus 10.

In short, fluid flows into the inlet annular space 24, across the reactor beds 12, 14, and out the outlet annular space 26 and the cylindrical pipe 22. In an alternative, the flow can be in the reverse direction.

The apparatus 10 further includes a solid distribution conduit 30 for delivering catalyst to the top of the reactor beds 12, 14, and a solid distribution conduit 32 for withdrawing catalyst from the bottom of the reactor beds 12, 14. The apparatus 10 further includes a first fluid conduit 40 for delivering the fluid to be reacted to the catalyst beds 12, 14. The first fluid conduit 40 is in fluid communication with the inlet annular space 24. The apparatus 10 includes a second fluid conduit 42 in fluid communication with the outlet annular space 26 and the cylindrical pipe 22 for withdrawing fluid product from the apparatus 10.

In another embodiment, the apparatus 10 further comprises more reactor beds. The reactor beds are cylindrically shaped, with each subsequent reactor bed having an inner radius and an outer radius. For the embodiment with a third reactor bed (not shown), the third reactor bed has a third inner radius and a third outer radius, with the third inner radius greater than the second outer radius, and where the third bed is disposed between the second bed and the cylindrical housing.

With more than two reactor beds, the reactor beds are disposed within the housing such that there is an annular space between pairs of nested reactor beds. The annular spaces can be grouped into two groups, a first set and a second set of annular spaces. The annular spaces for each group are selected from alternate spaces as one progresses from the inner cylindrical pipe to the outermost annular space. For flow and design considerations, it is most efficient to have a first set of alternating annular spaces in fluid communication with an inlet conduit, and a second set of alternating annular spaces in fluid communication with an outlet conduit.

While the invention has been described with what are presently considered the preferred embodiments, it is to be understood that the invention is not limited to the disclosed embodiments, but it is intended to cover various modifications and equivalent arrangements included within the scope of the appended claims.

1. An apparatus for fluid-solid contacting comprising:
a cylindrical housing;
a first annular shaped reactor bed wherein the first bed has a first inner radius and a first outer radius; and
a second annular shaped reactor bed wherein the second bed has a second inner radius and a second outer radius, with the second inner radius is greater than the first outer radius;
where the first and second reactor beds are disposed within the housing and the first reactor bed is disposed within the space defined by the inner radius of the second reactor bed.

2. The apparatus of claim 1 further comprising a solid distribution conduit for directing the flow of solid particles into the top of the reactor beds.

3. The apparatus of claim 1 further comprising a solid distribution conduit for collecting the flow of solid particles out of the bottom of the reactor beds.

4. The apparatus of claim 1 wherein the first and second beds define an intermediate annular space between the two beds, further comprising a first fluid conduit in fluid communication with the intermediate annular space between the two beds.

5. The apparatus of claim 4 wherein the first fluid conduit is an inlet conduit.

6. The apparatus of claim 4 wherein the first fluid conduit is an outlet conduit.

7. The apparatus of claim 1 wherein the first bed defines a cylindrical pipe space having a radius equal to the first inner radius, and the housing and second bed define an outer annular space between the housing and the outer surface of the second bed, further comprising a second fluid conduit in fluid communication with the cylindrical pipe space and the outer annular space.

8. The apparatus of claim 7 wherein the second fluid conduit is an outlet conduit.

9. The apparatus of claim 7 wherein the second fluid conduit is an inlet conduit.

10. The apparatus of claim 1 further comprising at least a third cylindrically shaped reactor bed wherein the third bed has a third inner radius and a third outer radius, with the third inner radius greater than the second outer radius, and where the third bed is disposed between the second bed and the cylindrical housing.

11. The apparatus of claim 10 wherein there are spaces between concentric pairs of reactor beds, a space between the outermost reactor bed and the housing, and a space defined by the inner radius of the innermost bed, further comprising:
an inlet conduit; and
an outlet conduit,
where the inlet conduit is in fluid communication with alternate spaces between the reactors and the outlet conduit is in fluid communication with the complementary set of spaces in the apparatus.
